(19) United States
(12) Patent Application Publication
(10) Pub. No.: US 2011/0044884 A1
(43) Pub. Date: Feb. 24, 2011

(54) HYDROGEN PRODUCTION FROM HYDROGEN SULFIDE

(75) Inventors: Alexander F Gutsol, San Ramon, CA (US); Alexander Fridman, Marlton, NJ (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Drexel University, Philadelphia, PA (US)

(21) Appl. No.: 12/598,956

(22) PCT Filed: May 7, 2008
(86) PCT No.: PCT/US08/62915

§ 371 Date: May 25, 2010

Related U.S. Application Data
(60) Provisional application No. 60/916,562, filed on May 7, 2007.

(51) Int. Cl. B01J 19/08; C01B 3/02; C01B 3/04; C01B 17/02

(52) U.S. Cl. 423/567.1; 422/186.21; 204/164; 423/648.1

(57) ABSTRACT

The present subject matter is directed to plasma dissociation of fluidic hydrogen sulfide to hydrogen and sulfur. A reactor is configured to have a plasma discharge and a vortex flow pattern. The plasma discharge provides energy to the hydrogen sulfide disassociation reaction and the vortex flow pattern helps to cause the condensation of sulfur molecules. The condensation of sulfur molecules helps to reduce the amount of energy input required to disassociate a certain amount of hydrogen sulfide. Additionally, the reactor may be configured to have a vortex flow pattern that provides for a recirculation zone in which relatively warm reaction products may exchange their heat energy with relatively cool input fluids.

### CROSS REFERENCE TO RELATED APPLICATIONS

This application claims benefit of U.S. Provisional Application No. 60/916,562, entitled, “HYDROGEN PRODUCTION FROM HYDROGEN SULFIDE”, filed May 7, 2007 (Atty. Docket No. DREX-1083USP), the entire contents of which are hereby incorporated herein by reference.

### FIELD OF THE INVENTION

The field of the invention pertains to the disassociation of hydrogen sulfide. The field of the invention may also be related to a chemical transformation using plasma.

### BACKGROUND

Greenhouse gas emissions are a recognized cause of global warming and pose a serious threat to the preservation of the environment. Scientists have been endeavoring to develop new scientific and technological innovations and approaches that can lead to the reduction of these emissions. Preliminary studies indicate that plasma dissociation of hydrogen sulfide may be a particularly promising technology for reducing greenhouse gas emissions. Hydrogen sulfide may be generated as a by-product in certain chemical processes, such as oil refining industry, as well being present in natural sources such as natural gas. In conventional methods of H₂S processing, such as the Claus method, all hydrogen from H₂S is transformed into water.

### SUMMARY

The present subject matter is directed to plasma dissociation of fluidic hydrogen sulfide to hydrogen and sulfur. A reactor is configured to have a plasma discharge and a vortex flow pattern. The plasma discharge provides energy to the hydrogen sulfide disassociation reaction and the vortex flow pattern helps to cause the condensation of sulfur molecules. The condensation of sulfur molecules helps to reduce the amount of energy input required to disassociate a certain amount of hydrogen sulfide. Additionally, the reactor may be configured to have a vortex flow pattern that provides for a recirculation zone in which relatively warm reaction products may exchange their heat energy with relatively cool input fluids. Again, this may reduce the required energy input to disassociate a certain amount of hydrogen sulfide and may also provide for an increased purity of the output streams.

In one exemplary and non-limiting embodiment, fluidic hydrogen sulfide (H₂S) is introduced into a reactor configured to establish a reverse-vortex flow pattern. Through chemical and physical energy imparted on the fluidic H₂S, the H₂S is disassociated to hydrogen and sulfur.

For the purposes of the present subject matter, fluidic hydrogen sulfide, sulfur or hydrogen may be a liquid, gas, or supercritical fluid. Fluid may be a substance that continually deforms under an applied shear stress without regards to the magnitude of the applied stress. Further, although the subject matter may be discussed in terms of pure substances, i.e. pure hydrogen sulfide, it should be understood that impurities or other compounds or elements may be present in one or more of the fluid streams discussed below.

Accordingly, in one aspect of the present invention there are provided reactors for dissociating hydrogen sulfide, comprising: a reaction chamber of generally cylindrical shape; at least one fluid inlet configured to introduce an input fluid into the reaction chamber in a direction generally tangential to a central axis of the reaction chamber, wherein the input fluid is comprised of hydrogen sulfide; at least one first outlet configured for outputting a first outlet fluid, wherein the first outlet and the fluid inlet are further configured to cause a reverse-vortex flow in the reaction chamber; a first electrode; and a second electrode connected to a power source, wherein the first electrode and the second electrode are disposed within the reaction chamber to provide for the generation of a plasma discharge within the reaction chamber.

Other aspects of the present invention provides methods for dissociating hydrogen sulfide, comprising: providing a plasma reactor, said plasma reactor comprising: a reaction chamber; at least one fluid inlet configured to introduce an input fluid into the reaction chamber in a direction generally tangential to a central axis of the reaction chamber; at least one first outlet configured for outputting a first outlet fluid, wherein the first outlet and the fluid inlet are further configured to cause a vortex flow in the reaction chamber; an optional second outlet configured for outputting a second outlet fluid; a first electrode; and a second electrode connected to a power source, wherein the first electrode and the second electrode have surfaces exposed within the reaction chamber to provide for the generation of a plasma discharge within the reaction chamber; and introducing hydrogen sulfide into the reaction chamber through the fluid inlet.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Other features of the subject matter are described below.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 is an exemplary and non-limiting illustration of a gliding arc discharge reactor using reverse-vortex flow;

FIG. 1ais a topside illustration of the reactor of FIG. 1, showing an exemplary and non-limiting example of how an input fluid may be introduced into the reactor;

FIG. 1b is a side view illustration of the reactor of FIG. 1 to further illustrate a reverse vortex-flow; and

FIG. 2 is an alternate exemplary and non-limiting illustration of a gliding arc discharge reactor using reverse-vortex flow.

### DETAILED DESCRIPTION

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The term “gliding arc” is used in the present subject matter as is understood by those skilled in the art. It should be understood that a plasma discharge in the present subject matter may be generated in various ways, for example, glow discharge. In a reactor implementing a glow discharge, a cathode current may be controlled mostly by the secondary electron emission, as occurs in glow discharge, instead of thermionic emission, as occurs in electrical arcs.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, references to values stated in ranges include each and every value within that range.

In the present disclosed subject matter, a gliding arc discharge plasma source is used to cause the dissociation of hydrogen sulfide, preferably into hydrogen and sulfur. A gliding arc discharge reactor is configured to cause a high-voltage electrical discharge to glide over the surface of one or more electrodes. The properties of the plasma discharge may be adjusted depending upon the configuration of the reactor. The reactor is further configured to utilize a reverse-vortex flow pattern. Reverse vortex flow means that the vortex flow has axial motion initially from a swirl generator to a “closed” end of reaction chamber. A reverse-vortex flow pattern may provide for, among other benefits that may not be specifically disclosed, the extraction of sulfur clusters due to the centrifugal effect of the spinning fluid, thus possibly increasing the efficiency of the reactor.

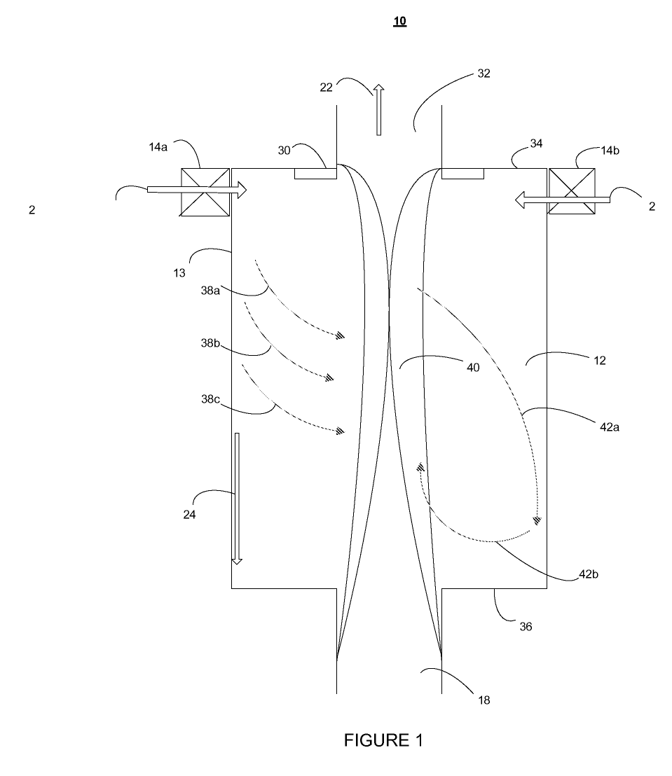

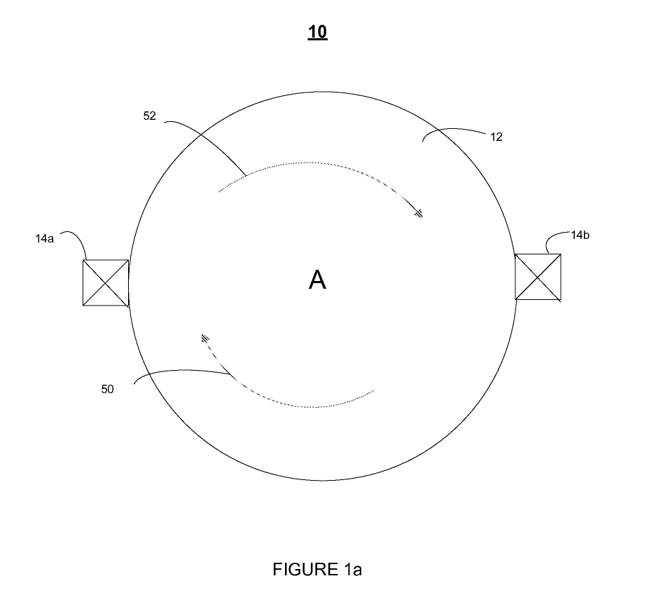

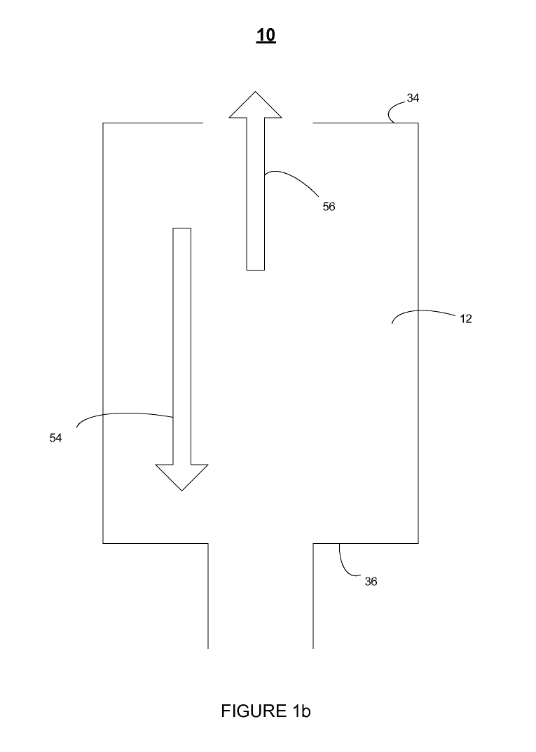

Referring now to the drawings, wherein like reference numerals designate corresponding structure throughout the views, and referring in particular to FIG. 1, a schematic view of an exemplary reactor, reactor 10, is illustrated. Reactor 10 includes reaction chamber 12. At or near top 34 of reactor 10, there is a swirl generator, one or more nozzles 14a, 14b, that cause rotation of the fluids in reaction chamber 12. Rotation of the fluids in reaction chamber 12 may be caused by various ways. In the present embodiment, nozzles 14a and 14b may be tangential nozzles that introduce input fluid 2 into reaction chamber 12 tangentially. This present embodiment is for illustrative purposes only, as the rotation may be caused by other means, such as baffles inside of reaction chamber 12. Further, in some embodiments, input fluid 2 may be introduced into reaction chamber 12 at or near sonic velocity having mostly the tangential component of the velocity vector.

FIG. 1a further illustrates the rotation of the fluids inside reaction chamber 12. Reactor 10 reaction chamber 12 has axis “A” that extends from the top (not shown), such as top 34 of reactor 10 to the bottom (not shown), such as bottom 36, of reactor 10. In the present embodiment, a rotational flow is generated by nozzles 14a and 14b introducing input fluid (not shown) into reaction chamber 12 tangential to axis “A”. A general flow pattern is caused whereby the fluids in the reactor rotate about axis “A”, shown by exemplary fluid flows 50 and 52.

It should also be understood that, although the reactor 10 of FIG. 1 is shown as having top 34 and bottom 36, reactor 10 may be arbitrarily oriented in space, and the significance of the spatial orientation of top 34 and bottom 36 are merely to provide reference points to illustrate the exemplary embodiment of reactor 10.

In one embodiment, input fluid 2 may be gaseous hydrogen sulfide. In another embodiment, input fluid 2 may be liquid hydrogen sulfide. In other embodiments, input fluid 2 may be supercritical hydrogen sulfide. It should be understood that input fluid 2 may also have substances or compounds other than hydrogen sulfide. The present subject matter is not limited to input fluid 2 being a pure fluid input, but rather, discusses the dissociation of the hydrogen sulfide component of input fluid 2 into hydrogen and sulfur.

Referring back to FIG. 1, nozzles 14a, 14b that help to generate a rotation of the fluids in reactor 10 may be located about a circumference of vortex reactor 10 and are preferably spaced evenly about the circumference. Although two nozzles, 14a, 14b, are illustrated in FIG. 1, it should be understood that this configuration is an exemplary configuration and that reactor 10 may have one nozzle or more than two nozzles, depending upon the configuration. In other embodiments, additional nozzles, not shown, may be placed in various locations on reactor 10.

Additionally, although the presently disclosed subject matter shown input fluid 2 to be the same fluid, it should be understood that one or more nozzles may be used to introduce one or more input fluids into reaction chamber 12. In the present embodiment, reactor 10 has input fluid 2 and two output streams, output stream 22 and output stream 24. Output stream 22 is preferably a hydrogen-rich stream primarily composed of hydrogen and output stream 24 is preferable a sulfur-rich stream primarily composed of sulfur. It should be understood that output streams 22 and 24 may not be pure hydrogen or sulfur, respectively, but may contain non-disassociated hydrogen sulfide and other compounds because of impurities in input fluid 2 or the mixtures of fluids in input fluid 2.

Input fluid 2 is introduced to reaction chamber 12 via nozzles 14a, 14b, the outputs of which are preferably oriented tangential relative to wall 13 of reaction chamber 12, as shown by FIG. 1a, which is a topside illustration of reactor 10. As shown in FIG. 1 a, reactor 10 has nozzles 14a and 14b. Input fluid 2 exits nozzles 14a and 14b and enters reaction chamber 12 in a generally tangential direction about an axis, such as axis “A” as illustrated in FIG. 1a.

By introducing input fluid 2 in this manner, as discussed above, a rotational force is imparted upon the fluids in reaction chamber 12, thus causing a rotation of the fluids in reaction chamber 12 in a clockwise direction in this embodiment. Thus, the velocity at which input fluid 2 enters reaction chamber 12 effects the rotational speed of the contents in reaction chamber 12. It should be noted that the input direction may be in a direction reverse to that shown in FIG. 1a. Further, it should be understood that one or more nozzles may be configured to introduce the input fluid in a direction dissimilar to other nozzles.

Referring back to FIG. 1, in an embodiment of the present subject matter, flange 30 and circular opening 32, located substantially at the center of flange 30, assist to form a vortex flow. In the present embodiment, the vortex flow is a reverse vortex flow, though it should be understood that the vortex flow may be a forward vortex flow.

FIG. 1b is provided to illustrate a reverse vortex flow pattern. Reactor 10 has top 34 and bottom 36. Reaction chamber 12 has two general flow patterns, exemplary fluid flow 50 and exemplary fluid flow 52. It should be understood that these flow patterns are one component of the flow of fluids in reaction chamber 12, with the rotational flow pattern being the other component. Generally in reactor 10, fluids flow in a downward motion from top 34 to bottom 36 outside near the outer wall of reactor 10 and in an upward motion from bottom 36 to top 34 near the center of reactor 10, as shown in Figure lb. It should be understood that other flow patterns may be used.

Referring back to FIG. 1, opening 32 in flange 30 is preferably circular, but may be other shapes such as pentagonal or octagonal. The size of circular opening 32 may be varied to configure reactor 10 for various flow patterns in reaction chamber 12. In this present embodiment, for example, the diameter of opening 32 in flange 30 may be from approximately 70% up to 95% of the diameter of reaction chamber 12 to form the reverse vortex flow.

The diameter of opening 32 may also be configured to establish, or prevent, a recirculation zone from forming. Reactor 10 may be configured to provide a way in which relatively hot fluids flowing from plasma region 40 may exchange a portion of their heat with fluids flowing to plasma region 40. For example, exemplary fluids 38a-c, which are flowing generally towards plasma region 40 receive heat from exemplary fluid 42a, which is flowing from plasma region 40. Exemplary fluid 42a, after exchanging heat with exemplary fluids 38a-c, may than flow back to plasma region 40, as shown by exemplary fluid 42b. Thus, a portion of the reaction heat generated in plasma region 40 and a portion of fluids in reaction chamber 12 recirculate within reactor 10. In one embodiment, if a recirculation zone is desired, the diameter of opening 32 in flange 30 may be approximately 10% up to 75% of the diameter of reaction chamber 12.

As discussed above, reverse vortex flow as used herein means that the vortex flow has axial motion initially caused by nozzles 14a and 14b along wall 13 of the chamber and then the flow turns back and moves along the axis to the “open” end of the chamber towards opening 32. An example in nature of this flow pattern may be similar to the flow inside a dust separation cyclone, or inside a natural tornado. Input fluid 2 travels in a circular motion, traveling in a downward and inward direction towards plasma region 40, as shown by exemplary fluids 38a-c.

In a suitable reactor, the dissociation reaction occurs in plasma region 40. Disassociated sulfur travels outward from plasma region 40 towards wall 13 of reactor 10 in an exemplary direction illustrated by flow direction labeled “Sulfur” whereas the hydrogen travels upwards to opening 32 in an exemplary direction shown by output stream 22. A portion of the disassociated sulfur condenses on wall 13 and travels downward along wall 13, shown by sulfur output stream 24, towards bottom 36 of reactor 10 outlet 18.

A reverse vortex flow in reaction chamber 12 causes the contents of reactor 10 in reaction chamber 12 to rotate around plasma region 40, while output stream 22 travels in a direction upwards from the bottom of reactor 10 to opening 32. Along with other benefits that may not be explicitly disclosed herein, the rotation may provide necessary time for the heating of the contents flowing to and in the relatively hot plasma region 40 as the contents move downwardly around central core region 40. Another benefit of the rotation may be that the reverse vortex flow may increase the residence time of reactants and products, for example, sulfur clusters, inside reaction chamber 12. Increased residence time may help to improve sulfur separation. In other words, as residence time increases, the molar percentage of hydrogen in output stream 22 may increase as well as the molar percentage of sulfur in sulfur output stream 24.

A vortex flow, such as the reverse-vortex flow described in FIG. 1, may provide for several benefits, some of which may not be explicitly described herein. For example, the flow may cause one two or more zones inside chamber 12, one being plasma region 40, the other being the remaining volume of reaction chamber 12. For example, in the present subject matter, a temperature differential is established between plasma region 40 to wall 13 of reactor 10. A central axis in plasma region 40 may have the highest temperature in reaction chamber 12, and as the radial distance from that central axis increases to wall 13, the temperature may decrease.

In the present embodiment, the temperature of input stream 2 defines the temperature near or at wall 13 of reaction chamber 12. In the dissociation of hydrogen sulfide, the temperature variance means that either most or a significant portion of the dissociation reaction occurs in relatively hot plasma region 40, depending upon the configuration and efficiency of reactor 10. Thus, in the present embodiment, the temperature at or near wall 13 is configured to be at or below the condensation temperature of sulfur output stream 24.

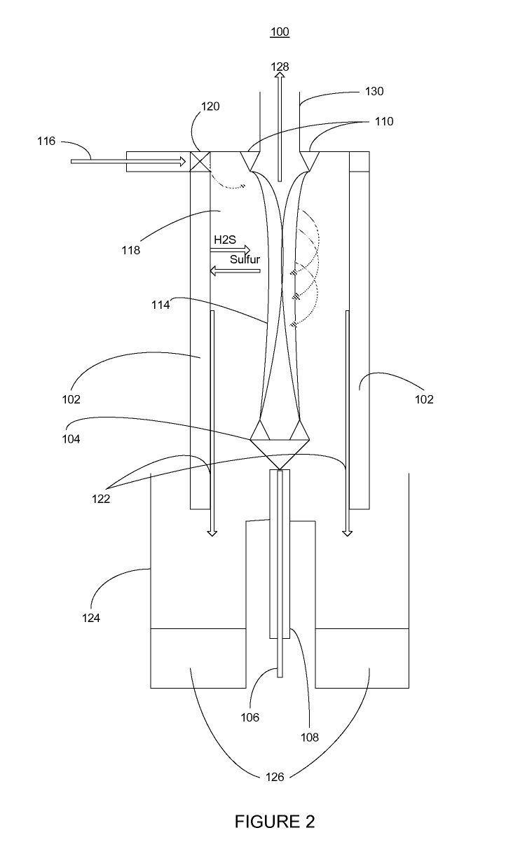

FIG. 2 is an illustration of a further embodiment of a gliding arc discharge reactor configured to have a reverse-vortex flow. In the present embodiment, reactor 100 has input stream 116 of hydrogen sulfide introduced into reactor 100 using a rotational flow pattern at near sonic speeds in a manner similar to that described in relation to FIG. 1, above. As previously mentioned, the introduction of input stream 116 imparts a rotational motion on the contents of reactor 100. This causes a centrifugal separation of hydrogen, shown by output stream 128, from sulfur, shown by output stream 122.

The dissociation process effectively commences in high temperature plasma zone 114 with hydrogen sulfide dissociating, or decomposing, to form sulfur molecules. Depending upon the conditions inside of reactor 100, the dissociated sulfur may form primarily sulfur dimers, S₂, while other sulfur clusters of varying formations occur, such as S₃→Sₙ. The sulfur clusters condense in the lower temperature areas of reactor 100. In the present embodiment, reactor 100 is configured so that plasma zone 114 creates a high enough temperature to dissociate at least a portion of the hydrogen sulfide in input stream 116. After the dissociation occurs, sulfur clusters form and begin to condense in the relatively lower temperature regions of reactor 100.

Without being bound by any theory of operation, it is believed that the condensation of sulfur clusters and a vortex flow pattern, such as the reverse-vortex flow of FIG. 1, may help to reduce the energy consumption of the reactor by allowing recovery of the energy of sulfur condensation. Depending upon the configuration of reactor 100, the centrifugal force may cause sulfur molecules and clusters to migrate to wall 102 of reactor 100 radially towards wall 102. The reverse-vortex flow may force the hydrogen sulfide to migrate radially towards the center of chamber 118, or plasma zone 114, of reactor 100.

A fluid stream is generated that rotates in the reactor 100, which may be cylindrical, and additionally travels downwards along the cylindrical wall, then radially towards the axis, then upwards along the axis. The sulfur migrating towards wall 102, shown as the flow labeled “Sulfur”, may condense and exchange its heat energy with the hydrogen sulfide, shown as the flow labeled “H2S” migrating towards plasma zone 114. A nearly 100% heat exchange efficiency occurs when the heat of condensation of the sulfur (85,520 kJ total) is completely absorbed by the incoming H₂S. It should be understood that the present subject matter is not limited to 100% efficiency.

The construction materials of reactor 100 may vary. In one embodiment shown in FIG. 2, wall 102 may be constructed of insulating material, such as quartz. Other configurations may include partial or complete metallic construction using materials such as stainless steel or Inconel®. The present subject matter is not limited to any particular material of construction, but rather, the subject matter may be applied using various construction materials.

Continuing with the construction of reactor 100, reactor 100 has wall 102 defining reaction chamber 118. Reactor 100 further has first electrode 104, which in the present embodiment is a high voltage electrode, connected to a power supply (not shown) via electrical connection 106. Reactor 100 also has second electrode 110, which in the present embodiment may be grounded or may have a different potential than first electrode 104. Plasma zone 114 may be initiated by evacuation of chamber 118 to a low enough atmospheric pressure as to cause the breakdown between first electrode 104 and second electrode 110. After the breakdown occurs, gas may be injected to gradually increase the pressure in chamber 118, along with current adjustment between first electrode 104 and second electrode 110, until desired conditions are reached. It should be understood that the electrodes may be constructed using various construction materials and may be shaped and sized in various manners to create plasma zone 114.

The properties of plasma zone 114 may be further altered and, more specifically, tuned by modifying the relative electrical potentials that may be found throughout reactor 100. For example, wall 102 of reactor 100 may be grounded in the present embodiment if wall 102 is constructed of metal, or be at a floating potential if it is made from a material such as quartz, but other embodiments may have an electrical potential applied to wall 102. The electrical properties of reactor 100 may be further modified by applying an electrical potential to other parts of reactor 100.

Reactor 100 further has a rotational flow generator, input nozzle 120, that introduces input fluid 116, which is a stream of hydrogen sulfide in this embodiment, into chamber 118. As discussed earlier in regards to FIG. 1 and FIG. 1a, preferably nozzle 120 is configured so that input fluid 116 is introduced into chamber 118 in a generally tangential direction, imparting a rotating force on the contents of chamber 118. Additionally, although one input nozzle is shown, nozzle 120, other configurations of reactor 100 may have more than one nozzle. As discussed previously, a rotational flow may be generated by various ways, such as a set of blades in chamber 118.

After dissociation, a fluidic output stream, stream 128 flows upwards out of reactor 100 through opening 130 and output stream 122, which in this embodiment is condensed sulfur, flow downward out of reactor 100 to collection tank 124 to form sulfur output 126.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is Claimed:

1. A reactor for dissociating hydrogen sulfide, comprising:
a reaction chamber;
at least one fluid inlet configured to introduce an input fluid into the reaction chamber, wherein the input fluid is comprised of hydrogen sulfide;
a swirl generator, wherein the swirl generator is configured to cause a rotational flow of fluids within the reaction chamber;
at least one first outlet configured for outputting a first outlet fluid, wherein the first outlet and the fluid inlet are further configured to cause a vortex flow in the reaction chamber, wherein the first outlet fluid is comprised of non-disassociated hydrogen sulfide and hydrogen;
a first electrode; and
a second electrode connected to a power source, wherein the first electrode and the second electrode have surfaces exposed within the reaction chamber to provide for the generation of a gliding arc discharge within the reaction chamber.

2. The reactor of claim 1, wherein the reaction chamber is cylindrical.

3. The reactor of claim 1, wherein the at least one fluid input further comprises a nozzle configured as the swirl generator, wherein the nozzle is configured to introduce the input fluid into the reaction chamber in a tangential direction generally perpendicular to an axis of the reaction chamber, wherein the nozzle is the swirl generator.

4. The reactor of claim 1, further comprising at least one second outlet configured for outputting a second outlet fluid, wherein the second outlet fluid is comprised of sulfur.

5. The reactor of claim 1, wherein the input fluid is a gas.

6. The reactor of claim 1, wherein the first outlet fluid is a gas.

7. The reactor of claim 1, wherein the second outlet fluid is a liquid.

8. The reactor of claim 1, wherein the first electrode is positioned proximate to a second outlet configured for outputting a second outlet fluid, wherein the second outlet fluid is comprised of sulfur.

9. The reactor of claim 1, wherein the second electrode is positioned proximate to the first outlet.

10. The reactor of claim 1, wherein the vortex flow is a reverse-vortex flow.

11. The reactor of claim 1, wherein the vortex flow causes a plasma zone to be located near an axis of the reaction chamber.

12. The reactor of claim 11, wherein the plasma zone is at a higher temperature than a location proximate to an inner surface of the reaction chamber thereby establishing a temperature differential across the reaction chamber.

13. The reactor of claim 11, wherein the plasma zone causes at least a portion of the hydrogen sulfide to dissociate into gaseous sulfur and gaseous hydrogen.

14. The reactor of claim 13, wherein the gaseous sulfur migrates from the plasma outward radially in a direction towards an inner surface of the reaction chamber.

15. The reactor of claim 14, wherein the gaseous sulfur releases heat and condenses to form sulfur clusters as the gaseous sulfur migrates toward the inner surface of the reaction chamber.

16. The reactor of claim 15, wherein at least a portion of the heat released during condensation is transferred to the input fluid as the input fluid migrates to the plasma zone.

17. The reactor of claim 1, wherein the input fluid is introduced into the reaction chamber at a speed of at least 90% of the speed of sound.

18. The reactor of claim 1, wherein the reaction chamber is constructed primarily from quartz.

19. The reactor of claim 1, wherein the reaction chamber is constructed primarily from metal.

20. The reactor of claim 1, wherein the first electrode or the second electrode are constructed primarily from stainless steel or inconel.

21. A method for dissociating hydrogen sulfide into hydrogen and sulfur, comprising:
providing a plasma reactor, said plasma reactor comprising:
a cylindrical reaction chamber;
at least one fluid inlet configured to introduce an input fluid into the reaction chamber in a tangential direction generally perpendicular to an axis of the reaction chamber;
at least one first outlet configured for outputting a first outlet fluid, wherein the first outlet and the fluid inlet are further configured to cause a reverse-vortex flow in the reaction chamber;
at least one second outlet configured for outputting a second outlet fluid;
a first electrode; and
a second electrode connected to a power source, wherein the first electrode and the second electrode have surfaces that are exposed within the reaction chamber to provide for the generation of a gliding arc discharge within the reaction chamber; and
introducing hydrogen sulfide into the reaction chamber through the fluid inlet.

22. The method of claim 21, further comprising reacting the hydrogen sulfide using the gliding arc discharge.

23. The method of claim 21, further comprising producing hydrogen-rich gas and collecting the hydrogen-rich gas exiting from the first outlet.

24. The method of claim 21, further comprising producing sulfur-rich liquid and collecting the sulfur-rich liquid exiting from the second outlet.

25. The method of claim 21, wherein the reaction chamber is constructed primarily from quartz or stainless steel.

26. Hydrogen made according to the process of claim 21.

27. Sulfur made according to the process of claim 21.
